(19) United States
(12) Patent Application Publication
(10) Pub. No.: US 2007/0063801 A1
(43) Pub. Date: Mar. 22, 2007

(54) System and method for magnetic resonance imaging

(76) Inventor: Evangelos Trifon Laskaris, Schenectady, NY (US)

Correspondence Address: Patrick S. Yoder;FLETCHER YODER, P.O. Box 692289, Houston, TX, 77269-2289, US

(21) Appl. No.: 11/229,377

(22) Filed: Sep. 16, 2005

(51) Int. Cl. H01F 7/00

(52) U.S. Cl. 335/301

(57) ABSTRACT

A magnetic resonance imaging (MRI) system is provided. The MRI system includes a cylindrical magnet for generating a static magnetic field. The magnet includes a cryostat having concave end plates and a first set of superconducting coils shielded with a second set of superconducting coils. The first and the second set of superconducting coils are disposed in the cryostat.

### BACKGROUND

The invention relates generally to the field of magnetic resonance imaging and more specifically to the field of magnetic resonance imaging of human extremities.

Magnetic resonance imaging (MRI) systems have become ubiquitous in the field of medical diagnostics. MRI is a non-invasive imaging technique used primarily in medical settings to produce high quality images of the inside of the human body. Generally, MRI is a multiplanar image method based on the interaction between radiofrequency (RF) electromagnetic fields and certain atomic nuclei in the body (usually hydrogen), after the body has been placed in a strong magnetic field. The imaged subject is kept in a static main magnetic field, known as the B0 field, and the nuclei of the imaged subject are excited by a sequence of pulses of a radio-frequency (RF) magnetic field, known as the B1 field. Over the two past decades, improved techniques for MRI examinations have been developed that now permit very high-quality images to be produced in a relatively short time. As a result, diagnostic images with varying degrees of resolution are available to the radiologists that can be adapted to particular diagnostic applications.

MRI systems having high magnetic field strengths are widely popular for full body investigations of patients, such as for in-vivo spectroscopy and image slice production, and typically have high diagnostic quality. However, these systems are expensive to use for routine partial body investigations of human extremities such as knees, feet/ankles, hands/wrists, and elbows. In particular, systems and techniques designed to acquire full body tomographs generally insert the entire patient into the bore of the scanning apparatus and, thereby, utilize a very expensive large system for imaging a part of the body that could be best done in a smaller, less expensive dedicated system. Further, whole-body systems are not designed for extremity imaging and are uncomfortable for patients. For example, it is inconvenient to undertake a partial body investigation of the human leg, in particular in the knee region, with current systems due to the geometry of such systems, which causes the patient to maintain an inconvenient posture during imaging procedures. For example, the patients may be instructed to control themselves in order to get their hands, wrists or elbows positioned into the “sweet-spot” of a whole-body high field system. In some investigations, the patients are facedown with their arms extended out over the head and are required to hold the affected hand, wrist, or elbow towards the center of the bore, while their body is advanced into the magnet bore for the scanning. Such positions are uncomfortable, especially for patients that are experiencing pain.

The development of ‘open’ architecture MRI enabled many claustrophobic and large patients to receive the benefits of MRI scanning with limited comfort. For example, an individual arm can be investigated approximately up to the elbow with system having smaller magnet and low magnetic field. Though open systems are more comfortable to the patients, they use ‘low field strength’ magnets, which may not provide the image quality and diagnostic capabilities of systems having higher magnetic field strengths. Further, current dedicated extremity MRI scanners generally use superconducting or low field permanent magnets operating at 1.0 Tesla or less, which is far less than the field strength of a typical whole-body MRI scanner. In addition, a conventional, cylindrical actively shielded MR magnet geometry for use in such a system may have a large outside diameter, which may prevent a patient from comfortably positioning himself relative to the imaging system. For example, in imaging a knee of one leg, the patient may have to position one leg inside the magnet with the other leg positioned uncomfortably outside the magnet outer diameter. The current dedicated extremity MRI scanners therefore provide limited patient comfort and are limited in benefits of high field diagnostic quality.

It is therefore desirable to provide a compact and high field MRI system for extremity imaging with the outstanding diagnostic performance such as high field image quality, faster scans with higher resolution, combined with maximum patient comfort and convenience at a lower cost.

### BRIEF DESCRIPTION

Briefly in accordance with one aspect of the present technique, a magnetic resonance imaging (MRI) system is provided. The MRI system includes a cylindrical magnet for generating a static magnetic field. The magnet includes a cryostat having concave end plates and a first set of superconducting coils shielded with a second set of superconducting coils. The first and the second set of superconducting coils are disposed in the cryostat.

In accordance with another aspect of the present technique, a method is provided for manufacturing a MRI system. The method includes providing a cylindrical magnet for generating a static magnetic field. The magnet includes a cryostat having concave end plates and a first set of superconducting coils shielded with a second set of superconducting coils. The first and the second set of superconducting coils are disposed in the cryostat.

In accordance with a further aspect of the present technique, a method is provided for imaging. The method provides for applying a high magnetic field in the range of about 1.5 Tesla to about 7 Tesla within an imaging volume of an extremity MRI system, detecting signals from an imaged portion placed within the imaging volume, and generating one or more images of the imaged portion based upon the detected signals.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of a magnetic resonance imaging system in accordance with aspects of the present technique;

FIG. 2 is a cross sectional view of the magnet for use in the magnetic resonance imaging system of FIG. 1; and

FIG. 3 illustrates position of a patient during limb imaging via the MRI system using magnet design of FIG. 2 in accordance with aspects of the present technique.

### DETAILED DESCRIPTION

The present technique is generally directed to magnetic resonance imaging (MRI) systems. Generally MRI systems may be used in a variety of imaging applications, such as for medical imaging screening. Though the present discussion provides examples in a medical imaging context, one of ordinary skill in the art will readily apprehend that the application of these MRI systems in non-medical imaging contexts, is well within the scope of the present technique.

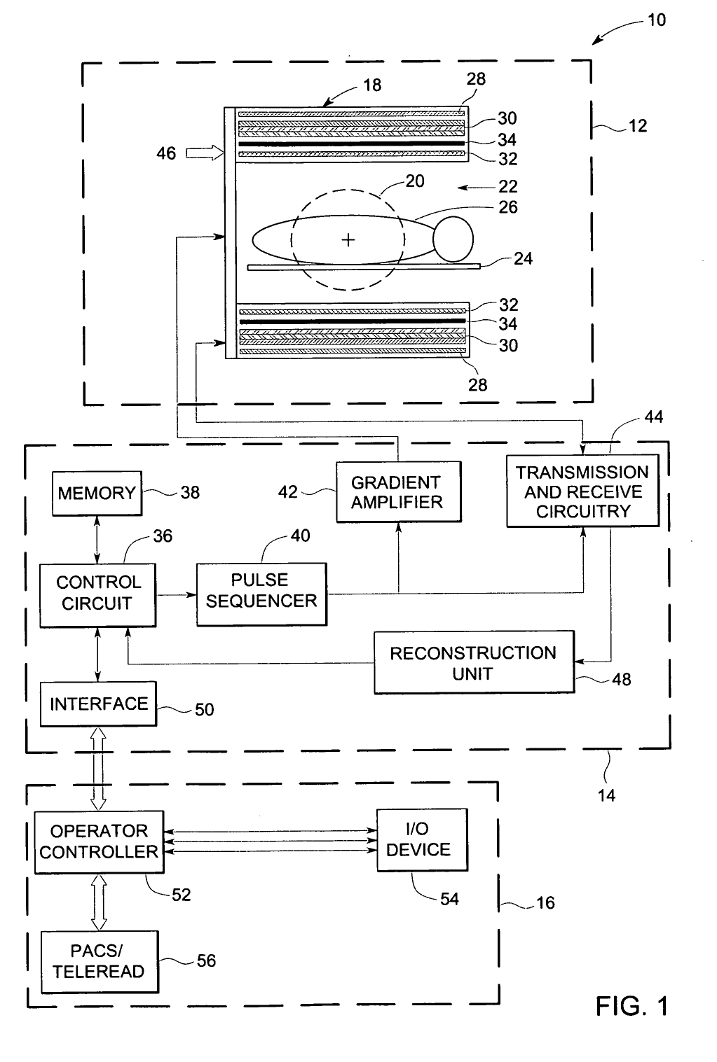

Referring now to FIG. 1, an exemplary cylindrical MRI system 10 is illustrated diagrammatically as including a scanner 12, scanner control circuitry 14, and system control circuitry 16. While MRI system 10 may include any suitable MRI scanner, in the illustrated embodiment the system includes an extremity scanner comprising an MR magnet assembly 18. The MR magnet assembly 18 provides a uniform, static magnetic field across an imaging volume 20 in the bore 22 of the MR magnet assembly 18. Optionally, a table 24 may be positioned to place all or a part of the patient 26 in a desired position within the imaging volume 20 for scanning.

The MR magnet assembly 18 includes a series of associated coils for producing controlled magnetic fields, for generating radiofrequency excitation pulses, and for detecting emissions from gyromagnetic material within the patient in response to such pulses. In the diagrammatical view of FIG. 1, a primary magnet coil 28 is provided for generating a primary or static magnetic field generally aligned with magnet bore 22. A series of gradient coils (such as X, Y, and Z-axis gradient coils) are grouped in a coil assembly 30 for generating controlled magnetic gradient fields in the specified direction during examination sequences, thereby providing positional data for the imaging volume 20. A radiofrequency coil 32 is provided for generating radiofrequency pulses for exciting the gyromagnetic material. The rf coil 32 generates a rf magnetic field that excites nuclear spins within patient 26 in imaging volume 20. In the embodiment illustrated in FIG. 1, rf coil 32 also serves as a receiving coil. Thus, rf coil 32 may be coupled with driving and receiving circuitry in passive and active modes for receiving emissions from the gyromagnetic material and for applying radiofrequency excitation pulses, respectively. Alternatively, various configurations of receiving coils may be provided separate from rf coil 32. Such coils may include structures specifically adapted for target anatomies, such as head coil assemblies, and so forth. Moreover, receiving coils may be provided in any suitable physical configuration, including phased array coils, and so forth. A radiofrequency shield 34 may be placed between the rf coil 32 and gradient coils assembly 30 to prevent the rf magnetic field from penetrating gradient coil assembly 30, thereby containing the RF energy inside the imaging volume 20 and preventing a loss of RF energy within the gradient coils 30.

The coils of scanner 12 are controlled by scanner control circuitry 14 to generate desired magnetic fields and radiofrequency pulses, and to read signals from the gyromagnetic material in a controlled manner. In the diagrammatical view of FIG. 1, control circuitry 14 thus includes a control circuit 36 for commanding the pulse sequences employed during the examinations, and for processing received signals. Control circuit 36 may include any suitable programmable logic device, such as a CPU or digital signal processor of a general purpose or application-specific computer. Control circuit 36 further includes memory circuitry 38, such as volatile and non-volatile memory devices for storing physical and logical axis configuration parameters, examination pulse sequence descriptions, acquired image data, programming routines, and so forth, used during the examination sequences implemented by the scanner.

The control circuit 36 activates a pulse sequencer 40 to initiate an MR data acquisition cycle. The pulse sequencer 40 controls the timing and activation of gradient amplifiers 42 and transmission and receive circuitry 44. The gradient amplifiers 42 includes amplifiers for each gradient field coil to supply drive current to the field coils in response to control signals from control circuit 36. The transmission and receive circuitry 44 includes additional amplification circuitry for driving rf coil 32. Moreover, where the rf coil 32 serves both to emit the radiofrequency excitation pulses and to receive MR signals, transmission and receive circuitry 44 will typically include a switching device for toggling the rf coil between active or transmitting mode, and passive or receiving mode. A power supply, denoted generally by reference numeral 46 in FIG. 1, is provided for energizing the primary magnet coil 28. The gradient magnetic fields and RF energy excite nuclear spins and cause an MR response signal to be emitted by tissue of patient 26 at a specified image plane within imaging volume 20. The transmission and receive circuitry 44 may acquire the emitted MR response signal from imaging volume 20 of patient 26, amplifies the emitted MR response signal, and provides this signal to a reconstruction unit 48. Reconstruction unit 48 produces data for an MR image of patient 26 at the imaging plane and provides the reconstructed image of the image plane to control circuit 36. Finally, scanner control circuitry 14 includes interface components 50 for exchanging configuration and image data with system control circuitry 16.

System control circuitry 16 may include a wide range of devices for facilitating interface between an operator or radiologist and scanner 12 via scanner control circuitry 14. In the illustrated embodiment, for example, an operator controller 52 is provided in the form of a computer workstation employing a general purpose or application-specific computer. The station also typically includes memory circuitry for storing examination pulse sequence descriptions, examination protocols, user and patient data, image data, both raw and processed, and so forth. The station may further include various interface and peripheral drivers for receiving and exchanging data with local and remote devices. In the illustrated embodiment, such devices include conventional input/output devices 54 such as keyboard, mouse, printer and/or display. The printer may be used to generate hard copy output of documents and images reconstructed from the acquired data. The display may facilitate operator interface and/or show reconstructed image. The printed or displayed image may be then used to aid the physician during a medical evaluation or diagnosis or during a medical procedure, such as surgery. In addition, system 10 may include various local and remote image access and examination control devices, represented generally by reference numeral 56 in FIG. 1. Such devices may include picture archiving and communication systems (PACS), teleradiology systems (TELEREAD), and the like.

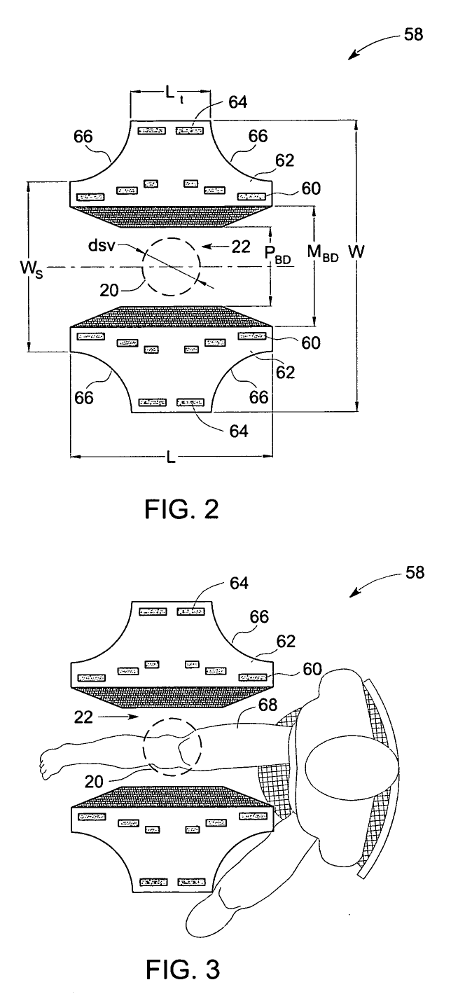

The exemplary MRI system 10, as well as other imaging systems based on magnetic resonance, employs a magnet assembly 18 for providing the static magnetic field. The magnet assembly 18 is generally an electromagnet made of low resistance coils in order to create a magnetic field strong enough to perform MRI. A cross sectional view of such an exemplary MR magnet 58 is illustrated in FIG. 2 according to aspects of the present technique.

As depicted in FIG. 2, the superconducting MRI magnet 58 comprises a cylindrical actively shielded main coil 60 in a vacuum insulated cryostat 62. In one implementation the magnet 58 is capable of generating the static or primary magnetic field in the range of about 1.5 Tesla to about 7 Tesla. In the depicted embodiment, the magnet 58 comprises a cryostat 62 and a first set of superconducting coils (main coils) 60 that are shielded with a second set of superconducting coils (shield coils) 64. It should be noted that, in one embodiment, the shield coils 64 have large diameter and/or are shorter in length than main coils 60. In one embodiment, the first and/or the second set of superconducting coils 60, 64 are niobium-titanium superconductor. The first and the second set of superconducting coils 60, 64 are disposed in the cryostat 62. The vacuum insulated cryostat 62 that surrounds the long main coils 60 and short shield coils 64 is designed to provide free space on the outside of the main coils by the use of thin concave end plates 66. The concave shape of the end plates 66 allows the end plates 66 to withstand a vacuum load. Due to the concave shape of the end plates 66, the vacuum load may be withstood even when the end plates 66 are reduced in thickness, such as to a thickness of a 1/8 of an inch of stainless steel.

In addition, the concave end plates 66 of the cryostat 62 allow a patient's leg 68 to be placed inside the magnet bore 22 with the other leg outside the magnet outer diameter during limb imaging, as illustrated in FIG. 3. In this way, the cryostat vacuum envelope provides the space needed for the patient to comfortably position one leg inside the magnet bore 22 and the other on the outside surface defined by the concave end plates 66.

Referring once again to FIG. 2, an exemplary embodiment of the MR magnet 58 has a total length (L) of about 58 cm, a total width (W) of about 80 cm and a top length (Lₜ) of about 20 cm. In this embodiment, the patient bore diameter (P_{BD}) is about 18 cm and the magnet bore diameter (M_{BD}) is about 28 cm. In addition, the side width of the magnet (Wₛ) is about 44 cm. In one embodiment, the diameter spherical volume (dsv) or the diameter of the imaging volume 20 is about 16 cm with an inhomogeneity of the magnet field of about 3.6 ppm (parts per million). The inhomogeneity of the magnet field of the magnet 58 for about 12 cm and 14 cm dsv is about 0.12 ppm and 0.62 ppm respectively. In the present example, the radial distance of the 5 G (gauss) line from the magnet center is 2 m while the axial distance of the 5 G line from the magnet center is 3 m. The strength of the static or primary magnetic field of the magnet in the described exemplary embodiment is about 3 Tesla.

As will be appreciated by one skilled in the art, the MRI magnet, as discussed in the various embodiments mentioned above, is designed to have a short length of actively shielded coil in combination with concave shaped cryostat end plates that provide the space need for the patient to comfortably position one leg inside the magnet bore and the other outside the magnet, on the concave cryostat end plate region. The proposed MRI magnet electromagnetic design and cryostat configuration enables imaging of human limbs or other extremities without compromising the functionality of the magnet or the comfort of the patient.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A magnetic resonance imaging (MRI) system, comprising:
a cylindrical magnet for generating a static magnetic field, the magnet comprising:
a cryostat having concave end plates; and
a first set of superconducting coils shielded with a second set of superconducting coils, wherein the first and the second set of superconducting coils are disposed in the cryostat.

2. The system of claim 1, wherein the superconducting coils of the second set are larger in diameters than the superconducting coils of the first set.

3. The system of claim 1, wherein the superconducting coils of the second set are shorter than the superconducting coils of the first set.

4. The system of claim 1, wherein the concave end plates are designed to withstand a vacuum load.

5. The system of claim 1, wherein at least one of the first or the second set of superconducting coils is niobium-titanium superconductor.

6. The system of claim 1, wherein the static magnetic field is in the range of about 1.5 Tesla to about 7 Tesla.

7. The system of claim 6, wherein the static magnetic field is about 3 Tesla.

8. The system of claim 1, further comprising a plurality of gradient coils and a radiofrequency coil to generate a plurality of gradient fields and a radiofrequency field respectively.

9. The system of claim 8, further comprising a radiofrequency shield for shielding radiofrequency emissions from the radiofrequency coil from interfering with the plurality of gradient fields.

10. The system of claim 8, further comprising driver circuitry coupled to the plurality of gradient coils and to the radiofrequency coil for generating controlled pulse sequences.

11. A method of manufacturing a magnetic resonance imaging (MRI) system, comprising:
providing a cylindrical magnet for generating a static magnetic field, the magnet comprising a cryostat having concave end plates and a first set of superconducting coils shielded with a second set of superconducting coils, wherein the first and the second set of superconducting coils are disposed in the cryostat.

12. The method of claims 11, wherein the concave end plates are configured to withstand a vacuum load.

13. The method of claim 11, wherein at least one of the first or the second set of superconducting coils is niobium-titanium superconductor.

14. The method of claim 11, comprising providing a plurality of gradient coils and a radiofrequency coil.

15. The method of claim 14, comprising providing driver circuitry coupled to the plurality of gradient coils and to the radiofrequency coil.

16. The method of claim 11, comprising providing a radiofrequency shield.

17. The method of claim 11, wherein the superconducting coils of the second set are larger in diameters than the superconducting coils of the first set.

18. The method of claim 11, wherein the superconducting coils of the second set are shorter than the superconducting coils of the first set.

19. A method of imaging, the method comprising:
applying a high magnetic field in the range of about 1.5 Tesla to about 7 Tesla within an imaging volume of an extremity MRI system;
detecting signals from an imaged portion placed within the imaging volume; and
generating one or more images of the imaged portion based upon the detected signals.

20. The method of claim 19, further comprising applying controlled pulses to a plurality of gradient coils and a radio frequency (rf) coil.
